(19) United States
(12) Patent Application Publication
(10) Pub. No.: US 2018/0184275 A1
(43) Pub. Date: Jun. 28, 2018

(54) METHOD AND APPARATUS FOR MOBILE DEVICE PROVISIONING IN NETWORK

(71) Applicant: SONIM TECHNOLOGIES, INC., San Mateo, CA (US)

(72) Inventor: Rajesh Doyijode, Bangalore (IN)

(21) Appl. No.: 15/851,241

(22) Filed: Dec. 21, 2017

Related U.S. Application Data
(60) Provisional application No. 62/438,429, filed on Dec. 22, 2016.

(51) Int. Cl. H04W 4/50; G06K 19/07; G06K 19/06; G06K 7/14; G06K 7/10; H04L 12/24

(52) U.S. Cl. CPC H04W 4/50; G06K 19/0723; G06K 19/06028; G06K 19/06037; H04L 67/02; G06K 7/1417; G06K 7/10297; H04L 41/0806; G06K 7/1413

(57) ABSTRACT

The embodiments herein provide a method for automatically provisioning one or more mobile device. The method includes extracting by the one or more mobile devices a wireless link identifier from a wireless link tag. Further, the method includes configuring a wireless link between the one or more mobile devices and an information provider based on the wireless link identifier. Furthermore, the method includes receiving at the one or more mobile devices a provision configuration from the information provider over the wireless link and provisioning the mobile device by configuring the provision configuration.

This application claims the benefit of U.S. Provisional Application No. 62/438,429, filed 22 Dec. 2016.

### FIELD OF INVENTION

This disclosure relates generally to a mobile electronic device and provisioning thereof in a network environment and, more particularly, to a method and an apparatus of administrating mobile device provisioning and security management in a communication network.

### BACKGROUND

Provisioning involves the process of preparing and equipping a communication network to facilitate new services to mobile devices connected to the communication network. Applications of mobile device management (MDM) or mobile device provisioning are broad and continue to increase. Examples of mobile device management applications include managing the mobile device in a work place by an administrative device or a server to obviate a security breach. Examples of managing the mobile device include controlling activities of the mobile device, securing sensitive data on the mobile device, configuring network connections etc.

Services pertaining to the work place can require custom software or applications. It becomes cumbersome for an employer or a network administrator of the work place to install specific applications and configure the mobile device for seamless communication in the communication network. Further, each end-user may require a different set of facilities on the mobile device used by the end-user. Some native applications on the mobile device may also need to be disabled.

Conventionally, each mobile device is provisioned independently with software and configurations necessary for a seamless work environment. An initial set-up of the mobile device must be performed by the network administrator. The initial set-up with the mobile device includes, for example, configuring a wireless fidelity (Wi-Fi) access point name (APN), storing enterprise contacts, configuring virtual private network (VPN) details, adding custom wallpapers and ringtones, installing enterprise related applications and disabling irrelevant applications, etc.

Conventional methods include authenticating the end-user and the mobile device and transmitting provisioning information to the mobile device from the server. For example, the end-user operates the mobile device and attempts to connect to the communication network by requesting access. Requesting access can include attempting to connect to the communication network through a wireless fidelity (Wi-Fi™) protocol or any other wireless communication protocol. Through the communication link, the end-user may be required to provide authentication details. Based on a successful authentication, the provisioning information is transmitted from the server to the mobile device. The provisioning information is used to configure networking facilities on the mobile device and install applications required by the end-user. This requires a cumbersome mechanism to provision the mobile device since each mobile device expends network resources in requesting access to the communication network and to authenticate the request. There is a need to optimize network resources and mobile device resources to automatically provision the mobile device in the communication network.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### SUMMARY

Accordingly, the embodiments herein provide a method for automatically provisioning one or more mobile device. The method includes extracting by the one or more mobile devices a wireless link identifier from a wireless link tag. Further, the method includes configuring a wireless link between the one or more mobile devices and an information provider based on the wireless link identifier. Furthermore, the method includes receiving at the one or more mobile devices a provision configuration from the information provider over the wireless link and provisioning the mobile device by configuring the provision configuration.

In an embodiment, the provision configuration comprises information about at least one of an application to be provisioned at the mobile device, an operation of an application to be provisioned at the mobile device, a data item to be provisioned at the mobile device, and an operation of a data item to be provisioned at the mobile device.

In an embodiment, the provision configuration from the information provider is generated upon customization of information about at least one of an application to be provisioned at the one or more mobile devices, an operation of the application to be provisioned at the one or more mobile devices, a data item to be provisioned at the one or more mobile devices, and an operation of the data item to be provisioned at the one or more mobile devices, over a uniform resource link (URL).

In an embodiment, configuring the provision configuration at the one or more mobile devices includes at least one of provisioning an application at the one or more mobile devices, provisioning an operation of an application at the one or more mobile devices, provisioning a data item at the mobile device and provisioning an operation of a data item at the one or more mobile devices.

In an embodiment, the provision configuration is received in an encoded format such as extensible markup language (XML) or Java Script Object Notification (JSON) formats. In another embodiment, the wireless link tag is one of a near field communication (NFC) tag, a Bluetooth-Low Energy (BLE) beacon, a quick response (QR) code tag, a bar code tag, and a radio frequency identification (RFID) tag. Further, the wireless link identifier is extracted by scanning the wireless link tag using the one or more mobile devices.

In an embodiment, the method further includes generating by the one or more mobile devices a provision configuration tag comprising the provision configuration received from the information provider, receiving by the one or more mobile devices a provision configuration identifier by scanning the provision configuration tag using another mobile device, configuring a wireless link between the one or more mobile devices and the another mobile device based on the provision configuration identifier and transmitting by the one or more mobile devices the provision configuration to the another mobile device over the wireless link.

Accordingly, the embodiments herein provide a mobile device that includes a processor, a memory and provision controller, operably coupled to the memory and the processor. The provision controller is configured to extract a wireless link identifier from a wireless link tag, configure a wireless link between the mobile device and an information provider based on the wireless link identifier, receive a provision configuration from the information provider over the wireless link and provision the mobile device by configuring the provision configuration.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 illustrates an environment in which an information provider and a plurality of mobile devices are connected through a communication network, according to an embodiment disclosed herein.

FIG. 2 is a block diagram illustrating hardware components of the mobile device, according to an embodiment disclosed herein.

FIG. 3 is a flow diagram illustrating a method for automatically provisioning the mobile device, according to an embodiment disclosed herein.

FIG. 4 is a sequence diagram illustrating a method for automatically provisioning the mobile device, according to an embodiment disclosed herein.

FIG. 5 is a sequence diagram illustrating a method for automatically provisioning another mobile device, according to an embodiment disclosed herein.

FIG. 6A-6D illustrate a user interface in which one of a manual set-up and an automatic set-up to provision the mobile device, according to an embodiment disclosed herein.

### DETAILED DESCRIPTION OF INVENTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments. Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, engines, controllers, units or modules or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The embodiments herein disclose a method for automatically provisioning a mobile device. The method includes extracting by the mobile device a wireless link identifier from a wireless link tag and configuring a wireless link between the mobile device and an information provider based on the wireless link identifier. Furthermore, the method includes receiving at the mobile device a provision configuration from the information provider over the wireless link and provisioning the mobile device by configuring the provision configuration.

Conventional methods include transmission of configuration settings to a mobile device operating by an end-user in the workplace attempting to connect the mobile device to the communication network. The configuration settings are sent after successfully authenticating the end-user and the mobile device. For example, an end-user operates a mobile device and attempts to connect to the communication by requesting access. Requesting access can include attempting to connect to the communication network through a wireless fidelity (Wi-Fi™) protocol or any other wireless communication protocol. Through the communication link, the end-user can be required to provide authentication details. Based on a successful authentication, provisioning information is transmitted from the server to the mobile device. The provisioning information includes configuration settings pertaining to access point name (APN), storing enterprise contacts, configuring virtual private network (VPN) details, adding custom wallpapers and ringtones, installing enterprise related applications and disabling irrelevant applications. This requires a cumbersome mechanism to provision the mobile device since each mobile device expends network resources in requesting access to the communication network and to authenticate the request. There is a need to optimize network resources and mobile device resources to automatically provision the mobile device in the communication network.

Unlike conventional methods, the proposed method is for automatically provisioning a mobile device. The method includes extracting by the mobile device a wireless link identifier from a wireless link tag and configuring a wireless link between the mobile device and an information provider based on the wireless link identifier. Furthermore, the method includes receiving at the mobile device a provision configuration from the information provider over the wireless link and provisioning the mobile device by configuring the provision configuration. The method further includes generating by the mobile device a provision configuration tag comprising the provision configuration received from the information provider, receiving by the mobile device a provision configuration identifier by scanning the provision configuration tag using another mobile device, configuring a wireless link between the mobile device and the another mobile device based on the provision configuration identifier and transmitting by the mobile device the provision configuration to the another mobile device over the wireless link.

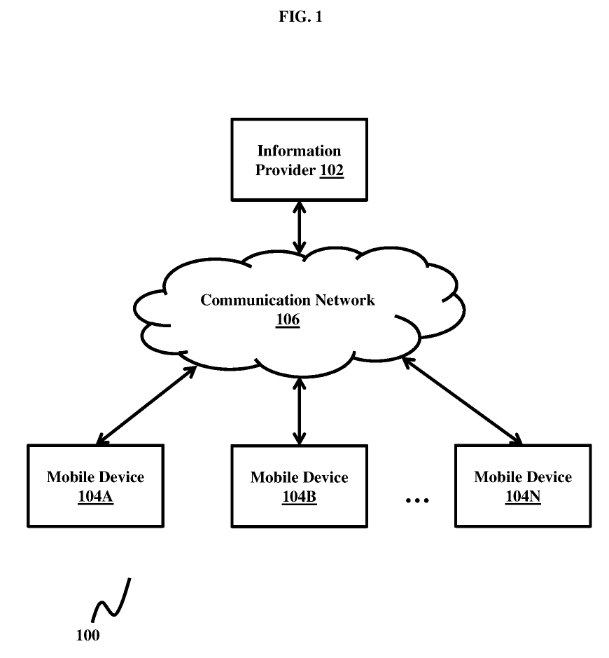

Referring now to the drawings, and more particularly to FIGS. 1 through 6D, where similar reference characters denote corresponding features consistently throughout the figures, there are shown preferred embodiments.

FIG. 1 illustrates a network environment 100 in which an information provider 102 is connected to a plurality of mobile devices 104A, 104B to 104N (hereinafter referred to as the mobile device 104) through a communication network 106. Each of the mobile devices 104 can be operated by an end-user.

The communication network 106 can include a data network such as, but not restricted to, the Internet, local area network (LAN), wide area network (WAN), metropolitan area network (MAN) etc. In certain embodiments, the communication network 106 can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS) etc. In some embodiments, the communication network 106 may include or otherwise cover networks or sub-networks, each of which may include, for example, a wired or wireless data pathway. The communication network 106 may include a circuit-switched voice network, a packet-switched data network, or any other network capable for carrying electronic communications. For example, the communication network 106 may include networks based on the Internet protocol (IP) or asynchronous transfer mode (ATM), and may support voice usage, for example, VoIP, Voice-over-ATM, or other comparable protocols used for voice data communications. In one implementation, the communication network 106 includes a cellular telephone network configured to enable exchange of text or SMS messages.

The communication network 106 may further include, but are not limited to, a personal area network (PAN), a storage area network (SAN), a home area network (HAN), a campus area network (CAN), a virtual private network (VPN), an enterprise private network (EPN), Internet, a global area network (GAN), and so forth. Embodiments are intended to include or otherwise cover any type of network, including known, related art, and/or later developed technologies to connect the information provider 102 and the mobile device 104 with each other.

The mobile device 104 can include any electronic device, such as a desktop computer, a portable computer, a smart phone, a tablet computer, a wearable device, and the like. The mobile device 104 can also include a display unit (not shown) for displaying any data. The display unit can include, but not limited to, a Cathode Ray Tube (CRT) display, a Liquid Crystal Display (LCD), a Light Emitting Diode (LED) display, and the like. Embodiments are intended to include or otherwise cover any type of display, including known, related art, and/or later developed technologies.

The information provider 102 includes a non-transitory computer medium that can be configured to receive and transmit communication requests and/or communication responses to and from the mobile device 104. The information provider 102 can be any or a combination of a server, a local computer connected to the communication network 106 or another mobile device connected to the communication network 106.

In some embodiments, the information provider 102 can facilitate a web interface accessible (not shown) via the Internet or the communication network 106 allowing a network administrator or an end-user to provide or customize provisioning information. The end-user or the network administrator may access the web interface at the mobile device 104. In some embodiments, the provision configuration is generated by the information provider upon customization of the provisioning information over a uniform resource link (URL). An administrator may provide the provisioning information through a website at the information provider 102 or from a computing device on the network 106. In some embodiments, the end-user may provide the provisioning information on a website at the mobile device 104. The provisioning information is encoded into a wireless link tag.

Provisioning information further includes configuration information about applications to be provisioned at the mobile device 104, operations of the applications to be provisioned at the mobile device 104, a data item to be provisioned at the mobile device 104, and an operation of the data item to be provisioned at the one or more mobile devices.

For example, the provisioning information can include configuration information pertaining to wireless network access points of the communication network 106 and VPN profiles for secure communication within the communication network 106. In some other embodiments, the provisioning information includes contact information such as, but not limited to, names, phone numbers and e-mails of all users and network administrators of the network 100 for quick and easy access to communication information. Some applications that are pre-integrated on the mobile device 104 can be disabled when the mobile device 104 is configured to be connected to the communication network 106. Further, the provisioning information includes sets of instructions to be executed by a processor of the mobile device 104 that disable ringtones and lowers volume for calls, alarms and notifications.

In an embodiment, the provisioning information includes a web link from which a special application is automatically downloaded, installed and activated as the device administrator application, which sets administrative policies on the mobile device 104. The restrictive polices include aspects relating to length of a password of the mobile device 104 can be or whether the end-user has access to all facilities of the mobile device 104. The provisioning information can be customized over a web link at the mobile device 104 or the information provider 102.

In some embodiments, the information provider 102 establishes a communication pathway with the mobile device 104 to provision the mobile device 104.

In an embodiment, the information provider 102 generates a quick response (QR) code that contains the provisioning information specified at the web interface. The mobile device 104 scans the QR code such that the provisioning information is extracted from the QR code.

In some embodiments, the provisioning information is encoded into near field communication (NFC) data and the end-user taps the mobile device 104 with the information provider 102 to connect the mobile device 104 over the communication network 106.

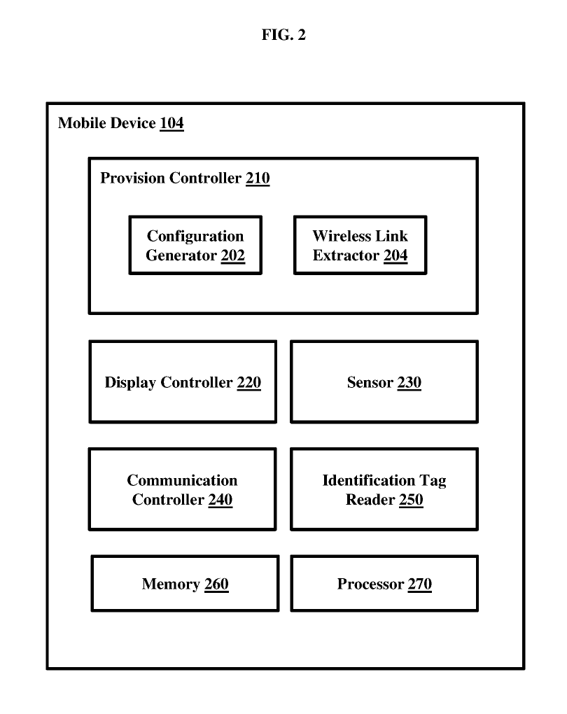

FIG. 2 is a block diagram illustrating hardware components of the mobile device 104. The mobile device 104 includes a provision controller 210, a display controller 220, a sensor 230, a communication controller 240, an identification tag reader 250, a memory 260 and a processor 270. The provision controller 210 further includes a configuration generator 202 and a wireless link extractor 204.

The configuration generator 202 is a hardware component that encodes information into a wireless link tag or a provision configuration identifier. The wireless link tag or the provision configuration identifier may be, but not limited to a QR code, a near field communication (NFC) tag, a radio frequency identification (RFID) tag and the like. The wireless link extractor 204 decodes encrypted information received by the mobile device 104 and extracts any information such as a uniform resource locator from the encrypted information.

The sensor 230 includes a set of chips that can scan a QR code. In some embodiments, the sensor 230 includes a NFC chip that enables the mobile device 104 to transmit or receive information using the NFC. In other embodiments, the sensor 230 can include a bar code reader. The identification tag reader 250 includes a radio frequency identification (RFID) tag which uses electromagnetic fields to read signals from the RFID tags. The communication controller 240 includes a signal transmitter and a signal receiver for receiving and transmitting data signals. In some embodiments, the communication controller 240 includes any or a combination of chipsets that support communication through wireless fidelity (Wi-Fi), Bluetooth, Bluetooth-Low Energy, 3G/4G communication protocols etc.

The processor 240 may be, but not restricted to, a Central Processing Unit (CPU), a microprocessor, or a microcontroller. The processor 240 is coupled to the provision controller 210, the display controller 220, the sensor 230, the communication controller 240, the identification tag reader 250, the memory 260 and the processor 270. The processor 270 executes sets of instructions stored on the memory 260.

The memory 260 may be, but not restricted to, an electronic, optical, magnetic, or other storage or transmission device capable of providing the processor 270 with computer-readable instructions. The memory 260 can include, but is not limited to, a floppy disk, a compact disk, a digital versatile disk, a magnetic disk, a memory chip, a read only memory (ROM), a random-access memory (RAM), all optical media, all magnetic tape or other magnetic media, or any other medium from which the processor 270 can read instructions. The instructions may comprise code from any suitable computer-programming language, including, but not restricted to, C, C++, C#, Visual Basic, Java, Python, Perl, and JavaScript.

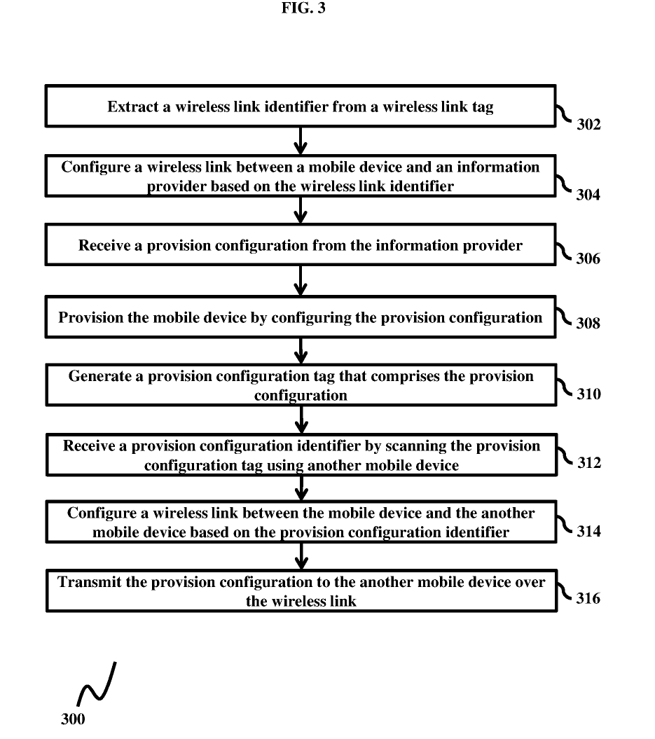

FIG. 3 is a flow diagram 300 illustrating a method for automatically provisioning the mobile device, according to an embodiment disclosed herein. Based on the provisioning information provided by the end-user or the network administrator at the web interface, the information provider 102 generates a wireless link tag comprising a wireless link identifier. The wireless link identifier directs to the provisioning information provided at the web interface. In some embodiments, the information provider 102 stores the provisioning information in a database. In some embodiments, the wireless link identifier is a uniform resource locator directed to a memory location where the provisioning information is stored. The wireless link tag can be, but not limited to, a QR code a NFC tag, a Bluetooth-low energy (BLE) beacon, a bar code tag, and a radio frequency identification (RFID) tag. The provision information is received in an encoded format that can be any one of extensible markup language (XML) or Java Script Object Notification (JSON) formats. For example, the provisioning information can be as shown below:

<? xml version=“1.0” encoding=“UTF-8”?>

<QRResponse>

<WiFi>

<SSID>WiFiName</SSID>
<Key>password</Key>

</WiFi>
<Url>http://www.sonimcloud.com/api/provisioning/7e7eo

03829e939</Url>

</QRResponse>

The above data is encoded in the wireless link tag. The wireless link tag is used by the end-user to provision the mobile device 104A. To do the provisioning the end-user re-boots the mobile device 104A (or factory reset the mobile device). The mobile device 104A is provisioned by scanning the wireless link tag, embedded with the provisioning information, shown on the web interface, using the sensor 230 or the identification tag reader 250 on the mobile device 104. At step 302, the wireless link identifier is extracted from the wireless link tag.

The wireless link tag is encrypted using any prevalent encryption methods such that only the wireless link extractor 204 can decrypt the contents embedded in the wireless link tag.

At step 304, the communication controller 240 configures the wireless link between the mobile device 104 and the information provider 102 based on the wireless link identifier extracted from the wireless link tag. In some embodiments, the information provider 102 receives a link with the uniform resource locator pointing to the provisioning information stored on the database through the established wireless link. The mobile device 104 further transmits a request for a provision configuration to the information provider 102. When the information provider 102 receives the request, the request is mapped to the provisioning information corresponding to the encoded information in the wireless link tag. At step 306, the information provider 102 sends the provisioning information to the communication controller 240 on the mobile device 104 as an XML file. The XML file is shown below:

<?xml version=“1.0” encoding=“UTF-8”?>
<Data>

<Networks>

```
  <WiFiNetworks>
  <WiFi>
```

<SSID>SonimWifi1</SSID>
<Key>ccp#98onoe8</Key>

</WiFi>

<WiFi>

<SSID>SonimWifi2</SSID>
<Key>hon$82ne3302!</Key>

</WiFi>

</WiFiNetworks>
<VPNNetworks>

<VPN>

<Name>testvpn1</Name>
<Type>0</Type>

<Server>testServer1</Server>

<User>rahul</User>
<Key>passwd</Key>

</VPN>
<VPN>

<Name>testvpn2</Name>
<Type>1</Type>

<Server>testServer2</Server>

<User>ahuja</User>
<Key>psswd</Key>

```
  </VPN>
  </VPNNetworks>
```

</Networks>
<URLs>

<URLname=“wallpaper”>http://tinyURL.com/pfwh8dr</URL>
<URLname=“jar”>http://tinyURL.com/obgk9eb</URL>
<URLname=“application”>http://tinyURL.com/pol639h</URL>
<URLname=“application”>http://tinyURL.com/obgk9eb</URL>

</URLs>
<Settings>

<Global>

<Locale>en_IN</Locale>

<ScreenLockPin>7864</ScreenLockPin>

<Packages>

<Disable>

<Package>com.android.calculator2</Package>
<Package>com.android.camera2</Package>

</Disable>
<Admin>
<Package>net.notify.notifymdm</Package>

<Package>com.android.test</Package>

</Admin>

</Packages>
<Sounds>

<RingTone>

<Name>RingToneName1</Name>

<Volume>6</Volume>
<Default>0</Default>
</RingTone>
<RingTone>

<Name>existing_RingToneName2</Name>

<Volume>4</Volume>
<Default>1</Default>
</RingTone>
<AlarmTone>

<Name>existing_AlarmToneName</Name>

<Volume>4</Volume>
<Default>1</Default>
</AlarmTone>
<NotificationTone>
<Name>existing_notification_toneName</Name>
<Volume>4</Volume>
<Default>1</Default>
</NotificationTone>

</Sounds>

</Global>
<AppSettings>

<Browser>

<Bookmarks>
<Bookmark>

<Name>Yahoo!!</Name>
<URL>http://www.yahoo.com</URL>

</Bookmark>
<Bookmark>

<Name>Google!!</Name>
<URL>http://www.google.com</URL>

</Bookmark>
</Bookmarks>

</Browser>
<ContactApp>

<Contacts>
<Contact>

<FirstName>Quentin</FirstName>
<LastName>Good</LastName>
<WorkNumber>1-652-8407779</WorkNumber>
<Email>vitae.sodales@eni.edu</Email>

<Contact>
BEGIN:VCARD VERSION:4.0
N:Gump;Forrest;;; FN:Forrest Gump
ORG:Bubba Gump Shrimp Co. TITLE:Shrimp Man
PHOTO;MEDIATYPE=image/gif:http://www.e
xa mple.com/dir_photos/my_photo.gif
TEL;TYPE=work,voice;VALUE=uri:tel:+11115
551212
TEL;TYPE=home,voice;VALUE=uri:tel:+1404
5 551212
ADR;TYPE=work;LABEL=“100 Waters
Edge\nBaytown, LA 30314\nUnited States of
America”:;;100 Waters
Edge;Baytown;LA;30314;United States of
America
ADR;TYPE=home;LABEL=“42 Plantation
St.\nBaytown, LA 30314\nUnited States of
America”:;;42 Plantation
St.;Baytown;LA;30314;United States of
America
EMAIL:forrestgump@example.com
REV:20080424T195243Z
END:VCARD
</Contact>

</Contacts>

</ContactApp>

</AppSettings>

</Settings>

</Data>

At step 308, the provision controller 210 parses the XML file and uses the information in the XML file to provision the mobile device 104. The mobile device application then parses the XML file and uses the information in the XML file to provision the mobile device 104. The above XML data can also be encrypted with a shared key which is kept private between the information provider 102 and the mobile device 104A or by using any of the other prevalent encryption methodologies used to transmit encrypted data.

In some embodiments, the mobile device 104 can be used to provision another mobile device. For example, the mobile device 104A is provisioned through steps 302 to 306, as shown in the flow diagram 300. The mobile device 104A is further used to provision any of the mobile devices 104B to 104N. In some embodiments, any mobile device of the mobile devices 104A to 104N that is provisioned, can be used to provision any mobile device of the mobile devices 104A to 104N that has not yet been provisioned.

Using the example of the mobile device 104A being provisioned, the steps 308 to 316 of the flow diagram 300 are explained. The mobile device 104A is provisioned using the steps of 302 to 306. The provisioned mobile device 104A stores the XML data in the memory 260. The XML data includes all the provisioning information used to provision the mobile device 104A. The provisioning information includes applications, wallpapers, ringtones and other files. The provisioning information is encoded to a provision configuration identifier generated by the provisioning controller 210. The provision configuration identifier can be, but not limited to a quick response code (QR code) a near field communication (NFC) tag, a Bluetooth-low energy (BLE) beacon, a bar code tag, and a radio frequency identification (RFID) tag. The provision information is received in an encoded format that can be any one of extensible markup language (XML) or Java Script Object Notification (JSON) formats.

In some embodiments, upon scanning the provision configuration identifier, the mobile device 104B is connected to the communication network 106 through a Wireless Fidelity (Wi-Fi) Direct™ protocol. At step 314, the communication controller 240 on the mobile device 104A establishes and configures a wireless link with the mobile device 104B based on the information encoded in the provision configuration identifier.

At step 316, through the established wireless link, all the provisioning information is transmitted to the mobile device 104B. The provisioning controller 210 of the mobile device 104B uses the transmitted provisioning information to configure and provision the mobile device 104B.

In an embodiment, provisioning the mobile device 104 includes provisioning multiple applications, provisioning an operation of an application, provisioning a data item and provisioning an operation of a data item at the mobile device 104. For example, the mobile device 104 can be provisioned to have configuration settings for various access points for connecting to the communication network 106, storing enterprise contacts, configuring virtual private network (VPN) details, adding custom wallpapers and ringtones, installing enterprise related applications and disabling irrelevant applications etc.

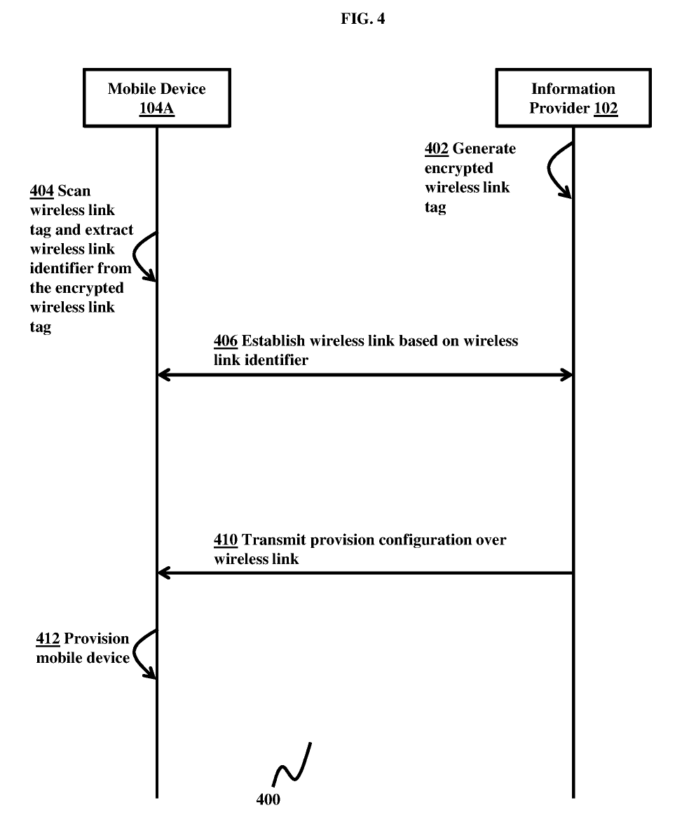

FIG. 4 is a sequence diagram 400 illustrating a method for automatically provisioning the mobile device, according to an embodiment disclosed herein. Provisioning information is provided or customized at the web interface by the network administrator. The web interface can be accessed at any of the mobile devices 104A to 104N or any other computing device connected to the Internet. The provisioning information is transmitted to the information provider 102 and stored on a database (not shown). Based on the location of the provisioning information, at step 402, the information provider 102 generates the wireless link tag. The wireless link tag is encoded with a wireless link that pertains to a uniform resource locator that points to the memory location of the stored provisioning information. The wireless link tag can be any of a NFC tag, a BLE beacon, a QR code tag, a bar code tag, and an RFID tag. At step 404, the wireless link identifier is extracted by the wireless link extractor 204 (shown in FIG. 2) by scanning the wireless link tag using the sensor 230 or the identification tag reader 250. At step 406, a wireless link is established between the information provider 102 and the communication controller 240 of the mobile device 104A (shown in FIG. 2) based on the wireless link identifier extracted. At step 408, the provisioning information or provision configuration is transmitted over the wireless link. At step 410, the provisioning controller 210 of the mobile device 104A uses the transmitted provisioning information to configure and provision the mobile device 104B.

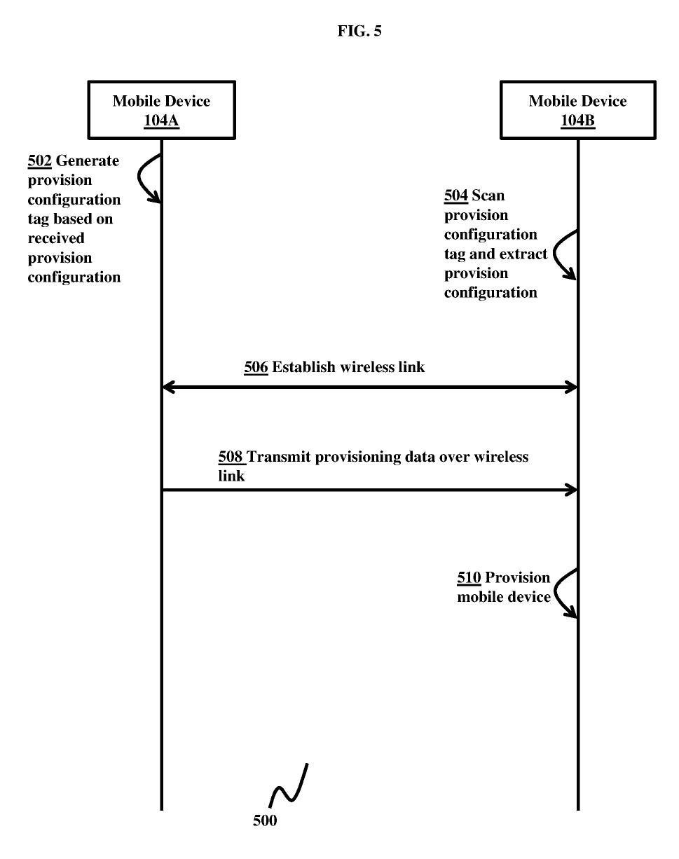

FIG. 5 is a sequence diagram 500 illustrating a method for automatically provisioning another mobile device 104B, according to an embodiment disclosed herein. The provisioned mobile device 104A stores the XML data in the memory 260. The XML data includes all the provisioning information used to provision the mobile device 104A. The provisioning information includes the applications, the wallpapers, the ringtones and other files. At step 502, the provisioning information is encoded to a provision configuration identifier generated by the provisioning controller 210. The provision information is received in an encoded format that can be any one of extensible markup language (XML) or Java Script Object Notification (JSON) formats.

At step 504, upon scanning the provision configuration identifier, the mobile device 104B is connected to the communication network 106 through a Wireless Fidelity (Wi-Fi) Direct™ protocol. At step 506, the communication controller 240 on the mobile device 104A establishes and configures a wireless link with the mobile device 104B based on the information encoded in the provision configuration identifier.

At step 508, through the established wireless link, all the provisioning information is transmitted to the mobile device 104B. At step 510, the provisioning controller 210 of the mobile device 104B uses the transmitted provisioning information to configure and provision the mobile device 104B. Provisioning the mobile device 104 includes provisioning multiple applications, provisioning an operation of an application, provisioning a data item and provisioning an operation of a data item at the mobile device 104. For example, the mobile device 104 can be provisioned to have configuration settings for various access points for connecting to the communication network 106, storing enterprise contacts, configuring virtual private network (VPN) details, adding custom wallpapers and ringtones, installing enterprise related applications and disabling irrelevant applications etc.

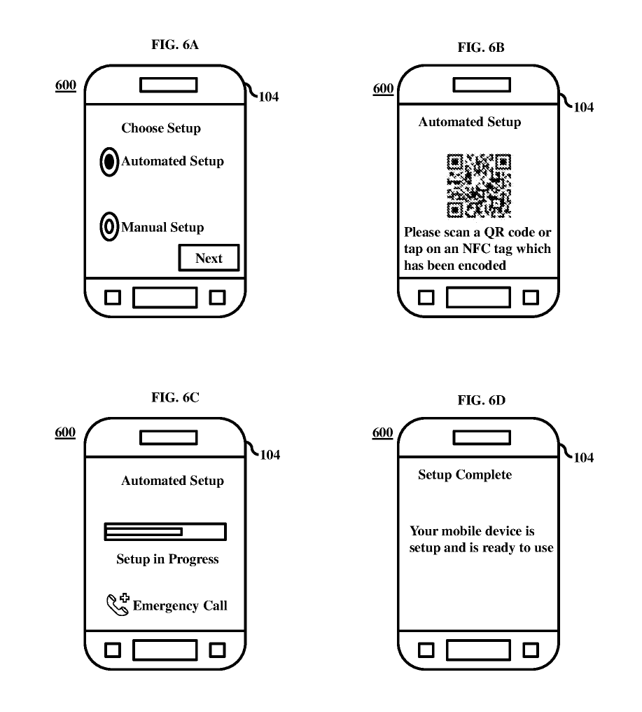

FIG. 6A-6D illustrate a user interface in which one of a manual set-up and an automatic set-up to provision the mobile device 104, according to an embodiment disclosed herein. In an embodiment, when an end-user attempts to connect the mobile device 104 to the communication network 106, the end-user is provided with a provisioning functionality. The provisioning functionality is integrated in a user interface 600 as shown in FIG. 6A to 6D.

Provisioning information is provided at the web interface by the network administrator. The web interface can be accessed at any of the mobile devices 104A to 104N or any other computing device connected to the Internet. The provisioning information is transmitted to the information provider 102 and stored on the database (not shown). Based on the location of the provisioning information, the information provider generates a wireless link tag. The wireless link tag is encoded with a wireless link identifier that pertains to a uniform resource locator pointing to the memory location of the stored provisioning information. The wireless link tag can be any of a NFC tag, a BLE beacon, a QR code tag, a bar code tag, and an RFID tag.

To do the provisioning, the mobile device 104 (or factory reset the mobile device 104) is booted up for the first time. Upon being switched on, the processor 270 executes sets of instructions stored in the memory 260 such that the user interface 602 is displayed on a screen of the mobile device 104. The display controller 220 causes the user interface 602 to be shown.

The end-user is provided with a choice between ‘Automated Setup’ and ‘Manual Setup’ as shown in FIG. 6A. If user chooses ‘Manual Setup’ then the end-user manually enters data to setup the mobile device 104. This includes installing applications, providing configuration settings manually such that the mobile device 104 is connected to the communication network 106. If the end-user chooses ‘Automated Setup’ then the user interface 600 prompts the end-user to scan the wireless link tag to extract the wireless link identifier embedded in the wireless link tag. The wireless link identifier is extracted by the wireless link extractor 204 (shown in FIG. 2) by scanning the wireless link tag using the sensor 230 or the identification tag reader 250.

The mobile device 104 then uses the wireless link identifier to automatically connect to the communication network 106. The wireless link is established between the information provider 102 and the communication controller 240 (shown in FIG. 2) based on the wireless link identifier extracted. The provisioning information or provision configuration is then transmitted over the wireless link. The provisioning controller 210 uses the transmitted provisioning information to configure and provision the mobile device 104. As shown in FIG. 6C, the user interface 600 displays a status bar to indicate progress in setting up of the mobile device 104 to be used in conjunction with the communication network 106.

Once, the setup is complete, the user interface 600 indicates that the provisioning is complete as shown in FIG. 6D.

The embodiments disclosed herein can be implemented through at least one software program running on at least one hardware device and performing network management functions to control the elements. The mobile device 104 retrieves the data from the wireless link tag to automatically connect to the communication network 106.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for automatically provisioning one or more mobile devices, comprising:
extracting by the one or more mobile devices a wireless link identifier from a wireless link tag;
configuring, by the one or more mobile devices, a wireless link between the mobile device and an information provider based on the wireless link identifier;
receiving at the one or more mobile devices a provision configuration from the information provider over the wireless link; and
provisioning the one or more mobile devices by configuring the provision configuration.

2. The method of claim 1, wherein the provision configuration from the information provider information about at least one of an application to be provisioned at the one or more mobile devices, an operation of the application to be provisioned at the one or more mobile devices, a data item to be provisioned at the one or more mobile devices, and an operation of the data item to be provisioned at the one or more mobile devices.

3. The method of claim 1, wherein the provision configuration from the information provider is generated upon customization of information about at least one of an application to be provisioned at the one or more mobile devices, an operation of the application to be provisioned at the one or more mobile devices, a data item to be provisioned at the one or more mobile devices, and an operation of the data item to be provisioned at the one or more mobile devices, over a uniform resource link (URL).

4. The method of claim 1, wherein configuring the provision configuration at the one or more mobile devices comprises at least one of:
provisioning an application at the one or more mobile devices;
provisioning an operation of an application at the one or more mobile devices;
provisioning a data item at the one or more mobile devices; and
provisioning an operation of a data item at the one or more mobile devices;

5. The method of claim 1, wherein the provision configuration is received in an encoded format.

6. The method of claim 1, wherein the wireless link tag is one of a near field communication (NFC) tag, a Bluetooth-low-energy (BLE) beacon, a quick response (QR) code tag, a bar code tag, and a radio frequency identification (RFID) tag.

7. The method of claim 1, wherein the wireless link identifier is extracted by scanning the wireless link tag using the one or more mobile device.

8. The method of claim 1, further comprising:
generating by the one or more mobile devices a provision configuration tag comprising the provision configuration received from the information provider; and
receiving by the one or more mobile devices a provision configuration identifier by scanning the provision configuration tag using another mobile device;
configuring a wireless link between the one or more mobile devices and the another mobile device based on the provision configuration identifier; and
transmitting by the one or more mobile devices the provision configuration to the another mobile device over the wireless link.

9. The method of claim 8, wherein the provision configuration tag is one of a near field communication (NFC) tag, a Bluetooth-low-energy (BLE) beacon, a quick response (QR) code tag, a bar code tag, and a radio frequency identification (RFID) tag.

10. A mobile device for automatic provisioning, the mobile device comprising:
a memory;
a processor; and
a provision controller, operably coupled to the memory and the processor, configured to:
extract a wireless link identifier from a wireless link tag;
configure a wireless link between the mobile device and an information provider based on the wireless link identifier;
receive a provision configuration from the information provider over the wireless link; and
provision the mobile device by configuring the provision configuration.

11. The mobile device of claim 10, wherein the provision configuration comprises information about at least one of an application to be provisioned at the mobile device, an operation of an application to be provisioned at the mobile device, a data item to be provisioned at the mobile device, and an operation of a data item to be provisioned at the mobile device.

12. The mobile device of claim 10, wherein the provision configuration is generated upon customization of information about at least one of an application to be provisioned at the mobile device, an operation of the application to be provisioned at the mobile device, a data item to be provisioned at the mobile device, and an operation of the data item to be provisioned at the mobile device, over a uniform resource link (URL).

13. The mobile device of claim 10, wherein the provision configuration is configured at the mobile device by at least one of:
provisioning an application at the mobile device;
provisioning an operation of an application at the mobile device;
provisioning a data item at the mobile device; and
provisioning an operation of a data item at the mobile device;

14. The mobile device of claim 10, wherein the provision configuration is received in an encoded format.

15. The mobile device of claim 10, wherein the wireless link tag is one of a near field communication (NFC) tag, a Bluetooth-low-energy (BLE) beacon, a quick response (QR) code tag, a bar code tag, and a radio frequency identification (RFID) tag.

16. The mobile device of claim 10, wherein the wireless link identifier is extracted by scanning the wireless link tag using the mobile device.

17. The mobile device of claim 10, wherein the provision controller is further configured to:
generate a provision configuration tag comprising the provision configuration received from the information provider; and
receive a provision configuration identifier by scanning the provision configuration tag using another mobile device;
configure a wireless link between the mobile device and the another mobile device based on the provision configuration identifier; and
transmit the provision configuration to the another mobile device over the wireless link.

18. The mobile device of claim 17, wherein the provision configuration tag is one of a near field communication (NFC) tag, a Bluetooth-low-energy (BLE) beacon, a quick response (QR) code tag, a bar code tag, and a radio frequency identification (RFID) tag.
